(19) United States
(12) Patent Application Publication
(10) Pub. No.: US 2011/0050198 A1
(43) Pub. Date: Mar. 3, 2011

(54) LOW-POWER VOLTAGE REGULATOR

(76) Inventors: Zhiwei Dong, Austin, TX (US); William W. K. Tang, Austin, TX (US); Axel Thomsen, Austin, TX (US)

(21) Appl. No.: 12/551,788

(22) Filed: Sep. 1, 2009

(51) Int. Cl. G05F 3/16

(52) U.S. Cl. 323/315

(57) ABSTRACT

A technique for reducing power dissipation and circuit area for a high voltage application includes creating a low-voltage, local power supply for use with local circuitry. In at least one embodiment of the invention, an apparatus includes an output node configured to provide a regulated output voltage. The apparatus includes a variable current source coupled to a first power supply node, wherein the variable current source is configured to provide an output current to the output node based on a control signal on a control node. The apparatus includes a feedback circuit configured to generate the control signal based on a mirrored current. The mirrored current is a mirrored version of a residual current flowing between the output node and a second power supply node. The regulated output voltage has a voltage level less than the voltage level on the first power supply node.

### BACKGROUND

1. Field of the Invention

This invention relates to integrated circuits and more particularly to voltage regulation on integrated circuits.

2. Description of the Related Art

In some integrated circuit applications, such as power conversion applications and driver applications, high-voltage devices are necessary to withstand high power supply voltage levels (e.g., approximately 24V or approximately 32V). In general, a high-voltage device includes a gate oxide layer that is thicker than the gate oxide layer of low-voltage device counterparts. Accordingly, a high-voltage device has a threshold voltage (Vₜ) magnitude greater than the magnitude of Vₜ(|Vₜ|) of a low-voltage device and has a gate oxide breakdown voltage greater than the gate oxide breakdown voltage of a low-voltage device. However, such high-voltage devices generally occupy a large area, have a high turn-on voltage, and have poor analog performance (e.g., poor device matching and large parasitic capacitance) as compared to low-voltage device counterparts. Thus, techniques for reducing integrated circuit area and power consumption and increasing power supply rejection in high power supply applications are desired.

### SUMMARY

A technique for reducing power dissipation and circuit area for a high voltage application includes creating a low-voltage, local power supply for use with local circuitry. In at least one embodiment of the invention, an apparatus includes an output node configured to provide a regulated output voltage. The apparatus includes a variable current source coupled to a first power supply node, wherein the variable current source is configured to provide an output current to the output node based on a control signal on a control node. The apparatus includes a feedback circuit configured to generate the control signal based on a mirrored current. The mirrored current is a mirrored version of a residual current flowing between the output node and a second power supply node. The regulated output voltage has a voltage level less than the voltage level on the first power supply node.

In at least one embodiment of the invention, a method includes sinking a residual current from an output node and adjusting an output current delivered from a first power supply node to the output node in response to a control signal on a control node. The control signal is at least partially based on a mirrored version of the residual current, thereby generating a local power supply voltage on the output node. the regulated output voltage has a voltage level less than the voltage level on the first power supply node.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a block diagram of an integrated circuit implementation of a high power supply application consistent with at least one embodiment of the invention.

FIG. 2 illustrates a block diagram of an exemplary isolated driver application consistent with at least one embodiment of the invention.

FIG. 3 illustrates a block diagram of an exemplary low-voltage input die of the exemplary isolated driver of FIG. 2.

FIG. 4 illustrates a block diagram of an exemplary high-voltage output die of the exemplary isolated driver of FIG. 2.

FIG. 5 illustrates a block diagram of a voltage regulator circuit.

FIG. 6 illustrates a block diagram of a voltage regulator circuit coupled to a high global supply voltage.

FIG. 7 illustrates a block diagram of a voltage regulator consistent with at least one embodiment of the invention.

FIG. 8 illustrates a circuit diagram of a voltage regulator consistent with at least one embodiment of the invention.

FIG. 9 illustrates a circuit diagram of a voltage regulator consistent with at least one embodiment of the invention.

FIG. 10 illustrates a circuit diagram of a typical self-biasing voltage regulator circuit.

FIG. 11 illustrates a circuit diagram of a low power and low current voltage regulator consistent with at least one embodiment of the invention.

The use of the same reference symbols in different drawings indicates similar or identical items.

### DESCRIPTION OF EMBODIMENTS OF THE INVENTION

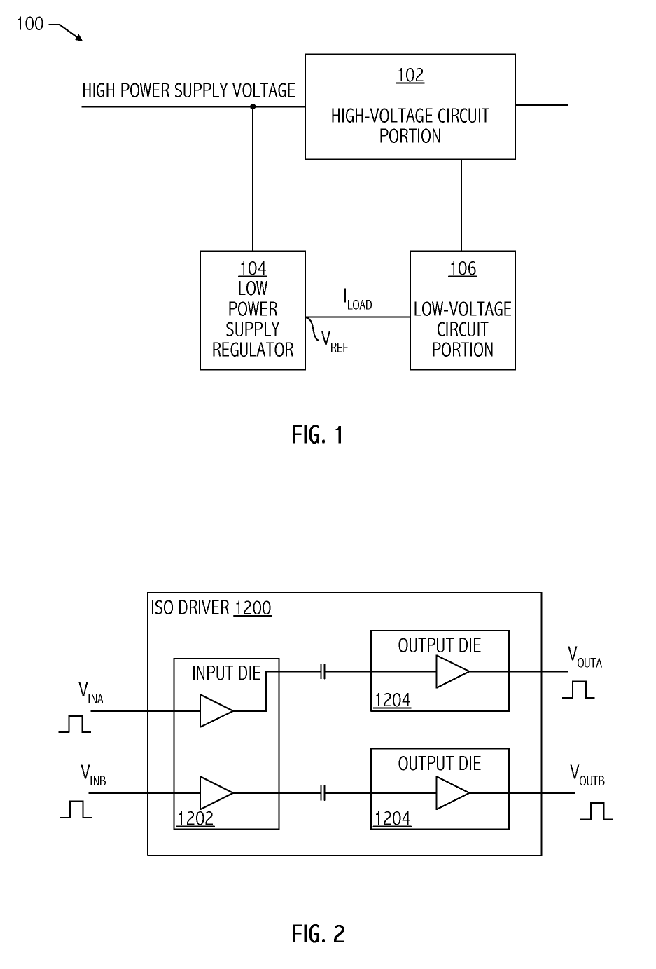

Referring to FIG. 1, an integrated circuit implementation of a high power supply voltage application (e.g., integrated circuit portion 100) includes a high-voltage circuit portion (e.g., circuit portion 102) and a local, low-voltage circuit portion (e.g., circuit portion 106). Circuit portion 102 includes circuits that operate at high voltage levels, e.g., driver circuits. Low-voltage circuit portion 106 includes local circuitry that implements functions that need not operate at high voltage levels. Low power supply regulator circuit 104 is configured to generate a low-voltage, local power supply for low-voltage circuit portion 106. Integrated circuit portion 100 may include a driver circuit, an isolator circuit, combinations thereof, or other suitable circuits. Exemplary isolator circuits are described in U.S. patent application Ser. No. 12/129,039, filed May 29, 2008, entitled “ISOLATOR CIRCUIT INCLUDING A VOLTAGE REGULATOR,” naming Donald E. Alfano, Timothy J. Dupuis, Zhiwei Dong, and Brett E. Etter as inventors; U.S. patent application Ser. No. 12/494,618, filed Jun. 30, 2009, entitled “ISOLATOR WITH COMPLEMENTARY CONFIGURABLE MEMORY,” naming Zhiwei Dong, Shouli Yan, Axel Thomsen, William W. K. Tang, Ka Y. Leung as inventors; U.S. patent application Ser. No. 12/414,387, filed Mar. 30, 2009, entitled “CAPACITIVE ISOLATION CIRCUITRY WITH IMPROVED COMMON MODE DETECTOR,” naming Zhiwei Dong, Shouli Yan, Axel Thomsen, William W. K. Tang, Ka Y. Leung as inventors; and U.S. patent application Ser. No. 12/414,379, filed Mar. 30, 2009, entitled “CAPACITIVE ISOLATION CIRCUITRY,” naming Phil Callahan, Ahsan Javed, Zhiwei Dong, Axel Thomsen, Donald E. Alfano, Timothy Dupuis, and Ka Y. Leung as inventors, which applications are hereby incorporated by reference.

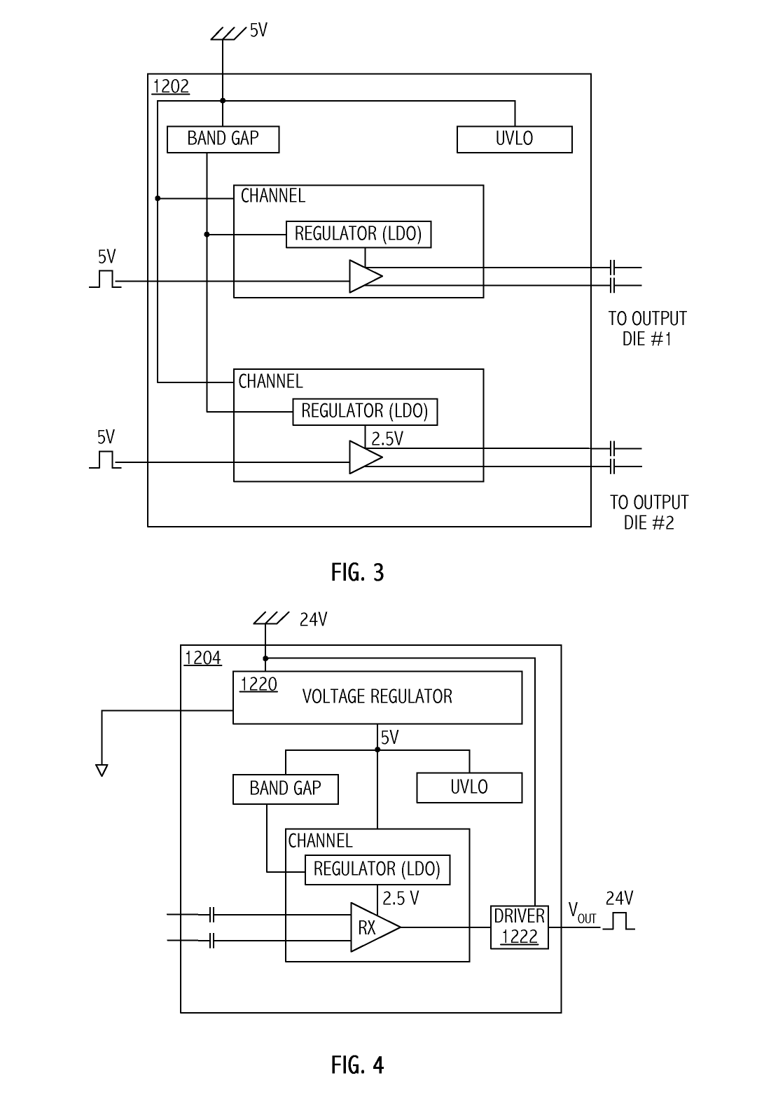

For example, referring to FIG. 2, in an exemplary isolated driver application (e.g., isolated driver 1200), an input die (e.g., input die 1202) receives one or more signals at a first voltage level (e.g., 5V) with respect to a first ground reference and communicates those signals across a capacitive isolation barrier to one or more output driver circuits (e.g., output die 1204) that drive those signals at a second voltage level (e.g., 24V) with respect to one or more additional ground references. Referring to FIG. 3, exemplary input die 1202 includes a band gap voltage reference circuit and an under voltage lockout circuit used to provide power to individual channel circuits. Individual channel circuits include a corresponding low dropout regulator circuit and a corresponding transmitter circuit. A typical under voltage lockout circuit is configured to turn off the power of the input die if the voltage drops below a predetermined operational value. A typical low dropout regulator is a DC linear voltage regulator that can operate with a very small input-output differential voltage to maintain a constant output voltage (e.g., 2.5V).

Referring to FIG. 4, an exemplary output die (e.g., output die 1204) includes a high-voltage circuit portion (e.g., driver 1222 that includes high-voltage devices and receives a high power supply voltage (e.g., 24V)). Output die 1204 also includes a low-voltage circuit portion. The low-voltage circuit portion of output die 1204 includes a band gap voltage reference, under voltage lockout circuitry, and channel circuitry (e.g., low dropout regulator and receiver circuitry), which include low-voltage devices and receive a substantially lower supply voltage level (e.g., 5V). A power supply regulator (e.g., voltage regulator circuit 1220) generates a voltage reference at the substantially lower voltage level based on the high voltage power supply level. In at least one embodiment, voltage regulator circuit 1220 includes at least one high-voltage device (e.g., a device coupled to the 24V power supply) and at least one low-voltage device (e.g., a device coupled to the 5V output node).

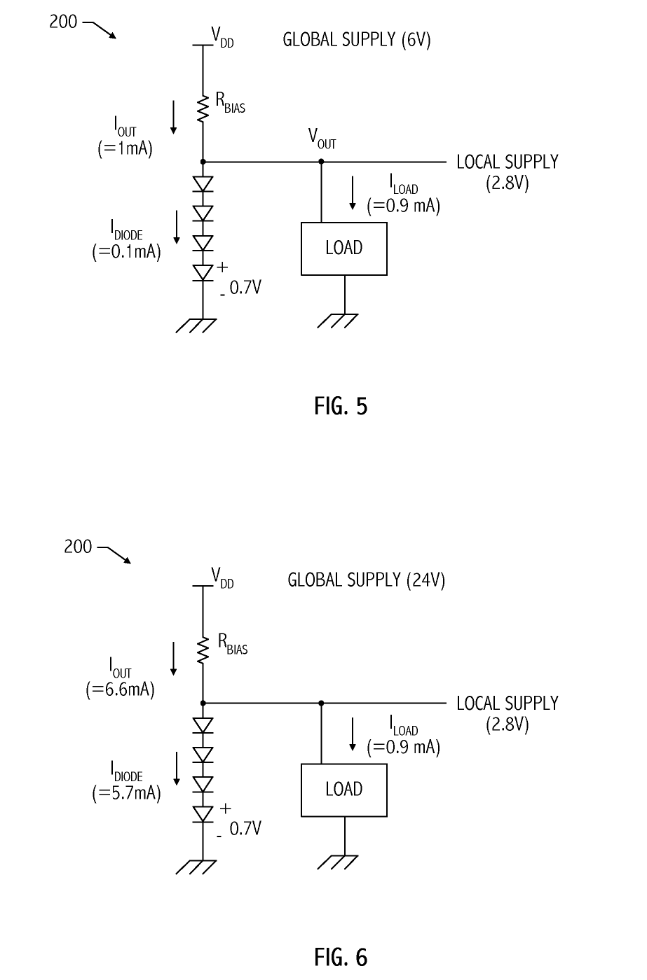

Referring to FIGS. 5 and 6, exemplary voltage regulator circuit 200 generates a low-voltage local power supply from a high-voltage global power supply. The low-voltage local power supply is regulated to a voltage (e.g., 2.8V) that is the sum of forward biased potentials of a number of diodes (e.g., four diodes, each diode having a forward bias potential of 0.7V). The diodes provide shunt regulation, i.e., a load can be drawing a particular amount of current (e.g., 0.9 mA) when biased at the local supply voltage and any residual current (e.g., I_{DIODE}) is channeled to ground by the diodes. As referred to herein, the residual current is the current flowing between the output node and ground, which is the difference between the output current (e.g., I_{OUT}) and the current flowing into a load (e.g., I_{LOAD}) coupled to the output node.

When the high-voltage global supply varies, a varying amount of current (e.g., I_{OUT}) flows through the biasing resistor (e.g., R_{BIAS}). Any additional current that results from the high-voltage global supply variations is also absorbed by the diodes. Due to the low on-resistance of the diodes, a change in the diode currents creates a relatively small change in the local supply voltage. Thus, the local supply is regulated and the current flowing to the load remains relatively constant.

The voltage regulation scheme of FIGS. 5 and 6 is inefficient. When the high-voltage global power supply varies, any additional current that is channeled through the diodes is wasted. For example, if the high-voltage global power supply voltage increases by four times (e.g., from 6V to 24V), the residual current flowing through the diodes increases substantially (e.g., from approximately 0.1 mA to approximately 5.7 mA, which is substantially greater than a four times increase). The residual current is channeled to ground and is wasted.

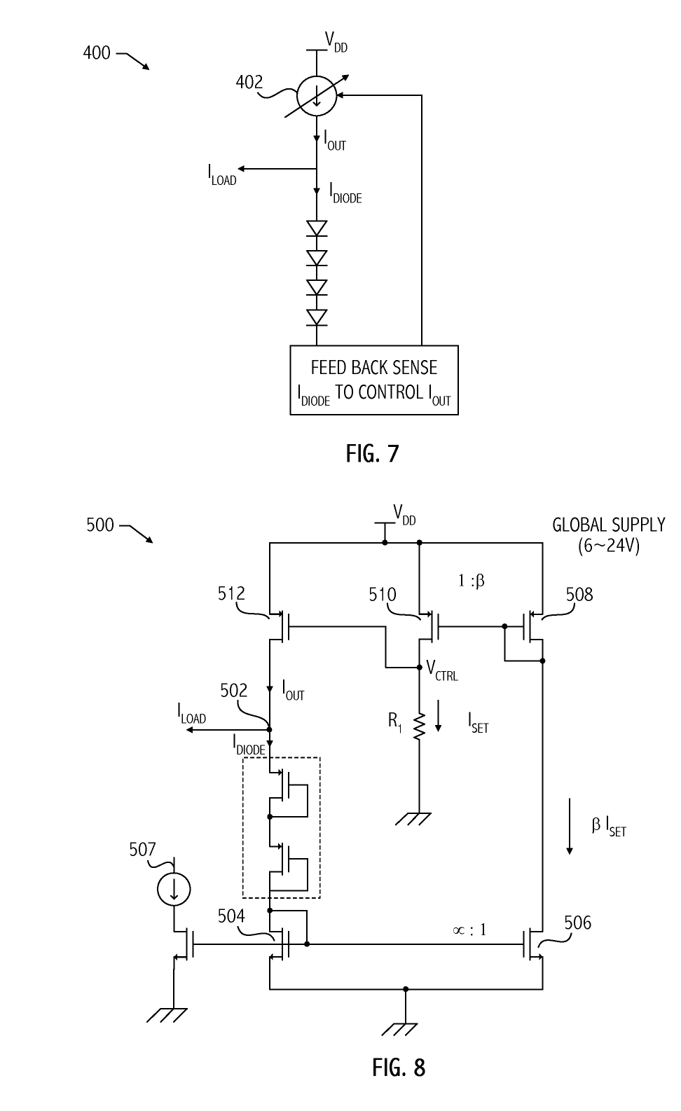

Referring to FIG. 7, voltage regulation circuit 400 reduces the power dissipation as compared to the voltage regulation technique of FIGS. 5 and 6. Rather than channeling additional residual current to ground when the high-voltage global power supply varies, a negative feedback loop limits the bias current variation, thereby reducing the residual bias current. The fixed bias resistor, R_{BIAS} of voltage regulator circuit 200, is replaced by dependent current source 402. The output current (e.g., I_{OUT}) of dependent current source 402 is controlled by the feedback loop. The feedback loop senses the diode current and adjusts I_{OUT} in a direction that counteracts any change in I_{OUT} as a result of DC variation of the high-voltage global power supply. In addition to rejecting the DC variation of the high-voltage global power supply, the feedback loop of voltage regulator circuit 400 rejects noise on the high-voltage global power supply. Thus the power supply rejection ratio improves substantially.

Referring to FIG. 8, an exemplary embodiment of the voltage regulation technique of FIG. 7 is manufactured in a complementary metal oxide semiconductor process. The shunting diodes of voltage regulator circuit 400 are implemented using transistors, each with its gate tied to its own drain. The diode current (I_{DIODE}) is sensed by a current mirror including devices 504 and 506. The output of the current mirror is gained by a high impedance to create a control voltage (V_{CTRL}), which is used to drive the gate of the output current source formed by device 512. Accordingly, a substantially fixed voltage level is provided on node 502 and a substantially fixed current level is provided through node 507. In at least one embodiment of voltage regulator circuit 500, bias currents are based on I_{SET}, which is the current through R₁. Note that in voltage regulator circuit 500, the voltage on I_{SET} is sensitive to noise on the high-voltage global power supply node since the gate-source voltage (i.e., V_{GS}) of device 512 is modulated by the noise on the high-voltage global power supply.

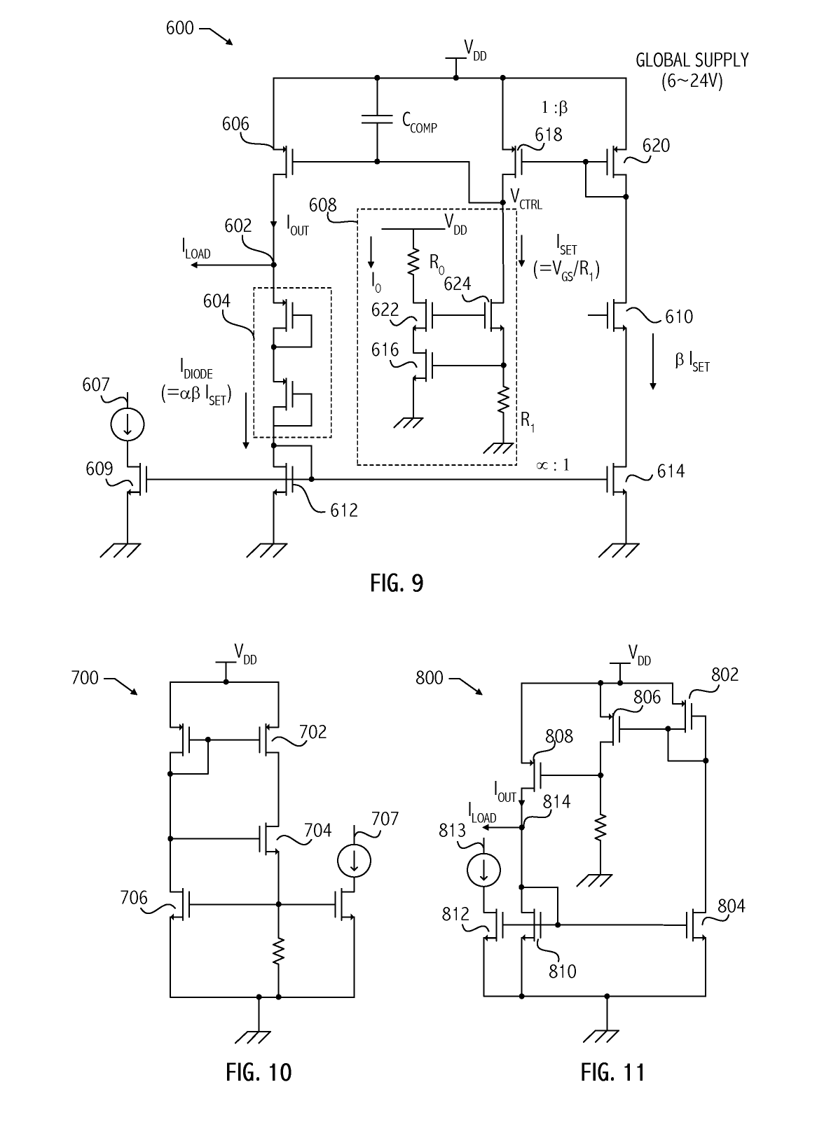

Referring to FIG. 9, to increase the rejection of noise on the high-voltage global power supply node, voltage regulator circuit 600 sets the branch bias currents using I_{SET}, which is a well-defined bias current of V_{GS}/R₁ of bias circuit 608 and is independent of the high-voltage global power supply voltage. Thus, the bias currents in voltage regulator circuit 600 remain relatively constant and well-defined as the high-voltage global supply varies. Note that although the branch current I₀ is generated with a conventional voltage clamp circuit, it does not present a power consumption issue. Rather, since branch current I₀ does not directly provide for I_{LOAD}, as compared to the voltage regulator circuits 200 and 300 of FIGS. 5 and 6, the branch current I₀ of voltage regulator circuit 600 of FIG. 9 can operate at a substantially lower current level than I_{LOAD}.

Still referring to FIG. 9, the feedback loop is compensated with a compensation capacitor (C_{COMP}) placed between the gate of the output current source and the high-voltage global power supply. Accordingly, a dominant pole is introduced into the feedback loop to maintain stability. In addition, the compensation capacitor enhances rejection of high-frequency noise by reducing the variation of V_{GS} of device 606 in response to variations on the high-voltage global power supply node.

Thus, voltage regulator circuit 600 efficiently creates a low-voltage local power supply from a high-voltage global power supply that is at a much higher potential, thereby limiting the supply voltage provided to the local circuitry. Accordingly, local circuitry can be built with low-voltage transistors in a high-voltage application. As a result, the local circuitry occupies less area than a design using high-voltage devices since low-voltage devices are much smaller compared to the high-voltage device counterparts. In addition, basic building blocks that have been previously designed with low-voltage transistors can be reused, thereby reducing design cycle time. Note that voltage regulator circuit 600 is self-biasing and does not require a startup circuit, e.g., bias circuit 608 provides a current that causes voltage regulator circuit 600 to move to a non-zero equilibrium point. Moreover, the resulting integrated circuit is more power-efficient than a high-voltage design and has enhanced power supply noise rejection from the negative feedback loop.

In at least one embodiment of voltage regulator circuit 600, additional savings in power and area may be achieved by using low-voltage devices in voltage regulator circuit 600. For example, devices 612, 614, and 616 may be implemented with low-voltage devices while devices 606, 618, 620, 622, and 624 are high-voltage devices. Accordingly, device 610 is included to shield device 614 from high voltages.

The techniques described above with regard to FIGS. 8 and 9 can be adapted to voltage regulator circuits for very low power applications (e.g., power supply levels of approximately 1V or less). Referring to FIG. 10, for a typical self-biasing voltage reference circuit to provide a reference voltage of V_{GS} (e.g., approximately 0.7V) a power supply of at least 3V_{GS} (e.g., 2.1V) is required to provide sufficient voltage headroom to operate devices 702, 704 and 706, under typical conditions with an acceptable power supply rejection ratio. However, in general, as the power supply voltage drops (e.g., for low-power applications), the available voltage headroom drops, and the power supply rejection ratio (PSRR) becomes more critical, and the typical self-biasing reference circuit 700 is less likely to provide a sufficiently stable reference voltage with respect to variations on the power supply.

Referring to FIG. 11, voltage regulator circuit 800 includes the variable current source, current mirroring, and feedback techniques described above with respect to voltage regulator circuit 500. Voltage regulator circuit 800 provides a reference voltage of V_{GS} (e.g., approximately 0.7V) using a power supply voltage of approximately 1V or less (e.g., 0.9V). For example, a power supply voltage of (2V_{GS}-Vₜ) (e.g., approximately 0.8V) provides sufficient headroom to operate devices 802 and 804 under typical conditions with an acceptable power supply rejection ratio.

The description of the invention set forth herein is illustrative, and is not intended to limit the scope of the invention as set forth in the following claims. For example, while the invention has been described in an embodiment in which current feedback is used, one of skill in the art will appreciate that the teachings herein can be utilized with voltage feedback. In addition, while the invention has been described in an isolated driver application, techniques described herein are applicable to other integrated circuit applications. Variations and modifications of the embodiments disclosed herein, may be made based on the description set forth herein, without departing from the scope and spirit of the invention as set forth in the following claims.

What is claimed is:

1. An apparatus comprising:
an output node configured to provide a regulated output voltage;
a variable current source coupled to a first power supply node, wherein the variable current source is configured to provide an output current to the output node based on a control signal on a control node; and
a feedback circuit configured to generate the control signal based on a mirrored current, wherein the mirrored current is a mirrored version of a residual current flowing between the output node and a second power supply node,
wherein the regulated output voltage has a voltage level less than the voltage level on the first power supply node.

2. The apparatus, as recited in claim 1, further comprising:
a diode circuit coupled to the output node and configured to generate a diode current, wherein the residual current is the diode current.

3. The apparatus, as recited in claim 2, further comprising:
a startup circuit configured to provide a bias current to the control node, wherein the bias current is insensitive to variations in a voltage level on the first power supply node.

4. The apparatus, as recited in claim 3, wherein the bias current is proportional to a gate-source voltage of a first device coupled to the control node.

5. The apparatus, as recited in claim 3, wherein the diode current is proportional to the bias current.

6. The apparatus, as recited in claim 1, further comprising:
a startup circuit coupled to the control node and configured to generate a bias current, wherein the startup circuit includes a resistor coupled between the control node and a second power supply node.

7. The apparatus, as recited in claim 1, wherein the variable current source includes at least one high-voltage device and the feedback circuit includes at least one low-voltage device.

8. The apparatus, as recited in claim 1, further comprising:
at least one circuit portion including at least one low-voltage device configured to receive the regulated output voltage.

9. The apparatus, as recited in claim 8, wherein the at least one circuit portion is a portion of an isolator circuit.

10. The apparatus, as recited in claim 7, wherein the feedback circuit further comprises:
a shielding circuit comprising at least one high-voltage device, wherein the shielding circuit is coupled to at least one low-voltage device of the feedback circuit.

11. The apparatus, as recited in claim 1, a compensation circuit configured to provide a dominant pole at the control node.

12. The apparatus, as recited in claim 1, wherein the voltage level on the first power supply node is approximately 1V or less.

13. The apparatus, as recited in claim 1, wherein the regulated output voltage has a voltage level of approximately 5V or less and the voltage level on the first power supply node is at least approximately 24V.

14. A method comprising:
sinking a residual current from an output node; and
adjusting an output current delivered from a first power supply node to the output node in response to a control signal on a control node, wherein the control signal is at least partially based on a mirrored version of the residual current, thereby generating a local power supply voltage on the output node,
wherein the regulated output voltage has a voltage level less than the voltage level on the first power supply node.

15. The method, as recited in claim 14, further comprising:
generating a control voltage based on the mirrored version of the residual current, wherein the output current is adjusted according to the control voltage.

16. The method, as recited in claim 14, further comprising:
frequency compensating a feedback loop including the control node by providing a dominant pole at the control node.

17. The method, as recited in claim 14, further comprising:
providing a bias current to the control node, wherein the bias current is substantially independent of variations of a voltage level on the first power supply node.

18. The method, as recited in claim 14, wherein the local power supply voltage has a voltage level of approximately 5V or less and the voltage level on the first power supply node is at least approximately 24V.

19. The method, as recited in claim 14, wherein the voltage level on the first power supply node is approximately 1V or less.

20. The method, as recited in claim 14, wherein sinking the residual current includes shunting the residual current from the output node through at least one diode circuit.

21. An apparatus comprising:
a first power supply node;
a second power supply node;
an output node;
means for generating a predetermined voltage on the output node by adjusting a current delivered from the first power supply node to the output node in response to a control signal on a control node, the control signal being at least partially based on a mirrored version of a residual current flowing between the output node and the second power supply node.

22. The apparatus, as recited in claim 21, further comprising:
a first circuit means coupled to the means for generating, wherein the first circuit means includes at least one high-voltage device and the means for generating includes at least one high-voltage device; and
a functional circuit means coupled to the output node, wherein the functional circuit means includes at least one low-voltage device.
